(19) United States
(12) Patent Application Publication
(10) Pub. No.: US 2011/0041677 A1
(43) Pub. Date: Feb. 24, 2011

(54) BALLISTIC-RESISTANT ARTICLES COMPRISING TAPES

(75) Inventors: Anton Peter De Weijer, Nijmegen (NL); Marinus Johannes Gerardus Journee, Loo (NL); Martinus Wilhelmus Maria Gemma Peters, Nijmegen (NL); Ernst Michael Winkler, Arnhem (NL)

Correspondence Address: OLIFF & BERRIDGE, PLC, P.O. BOX 320850, ALEXANDRIA, VA, 22320-4850, US

(73) Assignee: TEIJIN ARAMID B.V., Arnhem (NL)

(21) Appl. No.: 12/989,854

(22) PCT Filed: Apr. 27, 2009
(86) PCT No.: PCT/EP09/55046

§ 371 Date: Oct. 27, 2010

(30) Foreign Application Priority Data
Apr. 28, 2008 (EP) 08155265.5
Jan. 9, 2009 (EP) 09150309.4

(51) Int. Cl. F41H 5/04; B29C 43/20

(52) U.S. Cl. 89/36.02; 156/243; 89/904

(57) ABSTRACT

Ballistic-resistant moulded article comprising a compressed stack of sheets comprising tapes of a reinforcing material, characterised in that at least one sheet comprises woven tapes as weft and as warp, at least some of the tapes having a width of at least 10 mm. A method for manufacturing the ballistic-resistant moulded article is also claimed.

This is a U.S. National Stage Application of Application No. PCT/EP2009/055046 filed Apr. 27, 2009, which claims the benefit of European Application No. 08155265.5 filed Apr. 28, 2008 and European Application No. 09150309.4 filed Jan. 9, 2009. The disclosure of the prior applications is hereby incorporated by reference herein in their entirety.

### BACKGROUND

The present invention pertains to ballistic-resistant articles comprising tapes, and to a method for manufacturing thereof.

Ballistic resistant articles comprising tapes are known in the art.

WO 2006/107197 describes a method for manufacturing a laminate of polymeric tapes in which polymeric tapes of the core-cladding type are used, in which the core material has a higher melting temperature than the cladding material, the method comprising the steps of biasing the polymeric tapes, positioning the polymeric tapes, and consolidating the polymeric tapes to obtain a laminate.

EP 1627719 describes a ballistic resistant article consisting essentially of ultra-high molecular weight polyethylene which comprises a plurality of unidirectionally oriented polyethylene sheets cross-plied at an angle with respect to each other and attached to each other in the absence of any resin, bonding matrix, or the like.

WO 2008/040506 describes a process for producing a laminate built up from at least two monolayers of polymeric tapes wherein a first monolayer of parallel unidirectional tapes is formed, a second monolayer of parallel unidirectional tapes is formed, and wherein the monolayers are stacked in such a manner that the tapes in the monolayers are oriented in the same direction, with the tapes in one monolayer being offset to the tapes in adjoining monolayers. The thus-formed stack is then consolidated to form a laminate. If so desired, panels may be formed by stacking the laminates, e.g., in such a manner that the tapes in one laminate are in a direction perpendicular to tapes in adjoining laminates.

WO 2008/040510 describes a process for producing a fabric comprising at least a layer of unidirectionally arranged polymeric tapes wherein the tapes are woven with a binding thread and the tapes are consolidated with the thread at a temperature below the consolidation temperature. The monolayers of unidirectionally oriented polymeric tapes are combined with each other in cross-ply orientation.

U.S. Patent Application Pub. No. 2007/0070164 describes a mat structure formed at least partially from interwoven heat-fused monoaxially drawn tape fiber elements. The tape comprises a base or core layer of oriented polymer, and at least one covering layer of a heat-fusible polymer. To fuse the warp strips and the fill strips, the system is heated to fuse the surface layers of the strips, while the core of the tape is not melted.

U.S. Pat. No. 5,578,370 describes an impact resistant sheet suitable for antiballistic protection wherein tapes comprising a polypropylene core and polyethylene/polypropylene surface layers are woven in a plain weave or a twill weave.

EP 1403038 describes attaching reinforcing tapes to a shaped article. This may be done in the form of a woven cloth. The tapes preferably are core—surface layer tapes. This reference does not describe a compressed stack of sheets comprising tapes.

EP 1908586 describes layering tapes in an off-set arrangement.

EP 191306 describes a ballistic material based on fibers, which may also be tapes or ribbons. The fibers may, for example be woven. UHMWPE may be used.

U.S. Pat. No. 5,595,809 describes a ballistic material based on strips cut from woven fibers. The strips may in turn again be woven.

While the references mentioned above describe ballistic-resistant materials with adequate properties, there is still room for improvement. More in particular, there is need for a ballistic resistant material, which combines a high ballistic performance with a low areal weight and a good stability, in particular well-controlled delamination properties. The present invention provides such a material.

The material of the present invention has also processing advantages. In a number of ballistic materials known in the art, the tapes are used in unidirectional monolayers, which are then stacked to form a ballistic material. The stacking takes place in the form of a cross-ply, that is, two adjacent monolayers are placed in such a manner that the direction of the fibers or tapes in the unidirectional monolayer is at an angle, generally a 90° angle, to the direction of the fibers or tapes in an adjacent monolayer. This cross-plying process is an expensive step in the manufacture of ballistic materials, and therefore there is need for a process in which this cross-plying process can be dispensed with. The present invention provides such a process.

### DETAILED DESCRIPTION

The present invention pertains to a ballistic-resistant molded article comprising a compressed stack of sheets comprising tapes of a reinforcing material, wherein at least one sheet is a woven sheet, which comprises tapes as weft and as warp, at least some of the tapes having a width of at least 10 mm.

It has been found that the use of tapes with a minimum width of at least 10 mm leads to an increase of the ballistic performance of the molded article to a surprising extent. It has further been found that this invention allows the combination of a low content of a matrix material in combination with good delamination properties.

Further advantages of the present invention and of specific embodiments thereof will become clear from the further specification.

In the present invention, a tape is defined as an object of which the length, i.e., the largest dimension of the object, is larger than the width, the second smallest dimension of the object, and the thickness, i.e., the smallest dimension of the object, while the width is in turn larger than the thickness. More in particular, the ratio between the length and the width generally is at least 2, Depending on tape width and stack size the ratio may be larger, e.g., at least 4, or at least 6. The maximum ratio is not critical to the present invention and will depend on processing parameters. As a general value, a maximum length to width ratio of 200 000 may be mentioned. The ratio between the width and the thickness generally is more than 10:1, in particular more than 50:1, still more in particular more than 100:1. The maximum ratio between the width and the thickness is not critical to the present invention. It generally is at most 2000:1.

The width of the tape is at least 10 mm. It has been found that the selection of wider tapes leads to an increase in ballistic performance of the ballistic material based on woven monolayers. Preferably, the width of the tape is at least 20 mm, more in particular at least 40 mm. The width of the tape is generally at most 200 mm. The thickness of the tape is generally at least 8 microns, in particular at least 10 microns. The thickness of the tape is generally at most 150 microns, more in particular at most 100 microns.

Within the present specification, the term sheet refers to an individual sheet comprising tapes of a reinforcing material, which sheet can individually be combined with other, corresponding sheets. The sheet may or may not comprise a matrix material, as will be elucidated below.

In the present invention, at least one sheet in the ballistic-resistant molded article comprises woven tapes as weft and warp. Obviously, the effect of the present invention will be increased when more than one sheet comprises woven tapes as weft and warp. More in particular, it is preferred for at least 30% of the sheets in the ballistic-resistant molded article to comprise woven tapes as weft and warp, more in particular at least 50%, even more in particular at least 70%, still more in particular at least 85%, even more in particular at least 95%. Analogously, it is preferred for at least 30% of the tapes used to have a width of at least 10 mm as specified above, and optionally meet the other preferences specified in the specification, more in particular at least 50%, even more in particular at least 70%, still more in particular at least 85%, even more in particular at least 95%.

There are various ways in which tapes can be applied in warp and weft. The weft tape can cross over one, two, or more warp tapes, and the sequential weft tapes can be applied alternating or parallel.

One embodiment in this respect is the plain weave, wherein the warp and weft are aligned so that they form a simple criss-cross pattern. It is made by passing each weft tape over and under each warp tape, with each row alternating, producing a high number of intersections.

A further embodiment is based on the satin weave. In this embodiment, two or more weft tapes float over a warp tape, or vice versa, two or more warp tapes float over a single weft tape.

A still further embodiment is derived from the twill weave. In this embodiment, one or more warp tapes alternately weave over and under two or more weft tapes in a regular repeated manner. This produces the visual effect of a straight or broken diagonal ‘rib’ to the fabric.

A still further embodiment is based on the basket weave. Basket weave is fundamentally the same as plain weave except that two or more warp fibers alternately interlace with two or more weft fibers. An arrangement of two warps crossing two wefts is designated 2×2 basket, but the arrangement of fiber need not be symmetrical. Therefore it is possible to have 8×2, 5×4, etc.

A still further embodiment is based on the mock leno weave. Mock leno weave is a version of plain weave in which occasional warp tapes, at regular intervals but usually several tapes apart, deviate from the alternate under-over interlacing and instead interlace every two or more tapes. This happens with similar frequency in the weft direction, and the overall effect is a fabric with increased thickness, rougher surface, and additional porosity.

Each weave type has associated characteristics. For example, where a system is used in which the weft crosses one, or a small number, of warp tapes, and the individual weft tapes are used alternating, or almost alternating, the sheet will contain a relatively large number of intersections. An intersection, in this context, is a point where a weft tape goes from one side of the sheet, the A side, to the other side of the sheet, the B side and an adjacent weft tape goes from the B side to the A side of the sheet.

Where a system is used in which the weft crosses one, or a limited number of warp tapes, or vice versa, where the warp crosses one or a limited number of weft tapes, a large number of deflection lines will exist. Deflection lines occur where one tape goes from one side of the sheet to the other side. It is formed by the edge of the crossover tape. While not wishing to be bound by any theory it is believed that these deflection lines contribute to the dissipation of impact energy in the X-Y direction of the sheet.

Within the context of the present invention the use of plain weaves may be preferred, because they are relatively easy to manufacture, and because they are homogeneous in that a rotation of 90° will not change the nature of the material, combined with good ballistic performance.

Tape weaving is known in the art. For an attractive tape weaving process, reference is made to EP 1354991.

The tapes of reinforcing material in the warp and the weft may be the same or different. They can be of different materials, of different thickness, and of different widths. The use of different tapes may be advantageous for optimising the properties of the final product, but the use of the same tapes may be the same for reasons of process efficiency. In one embodiment, the ratio between the width of the tapes in the weft direction and the width of the tapes in the warp direction is between 5:1 and 1:5, in particular between 2:1 and 1:2.

In one embodiment of the present invention, the ballistic-resistant molded article according to the contains sheets comprising woven tapes as weft and as warp stacked on top of each other, the stacking being carried out in such a manner that the tape intersections of one sheet are not stacked on top of the tape intersections of neighboring sheets. In this manner, a more homogeneous product is obtained.

Tapes of any natural or synthetic material may in principle be used as reinforcing materials tapes in the present invention.

Use may be made of for instance tapes made of metal, semimetal, inorganic materials, organic materials or combinations thereof. It is essential that the tapes be suitable for use in ballistic applications, which, more specifically, requires that they have a high tensile strength, a high tensile modulus and a high-energy absorption, reflected in a high energy-to-break. It is preferred for the tapes to have a tensile strength of at least 1.0 GPa, a tensile modulus of at least 40 GPa, and a tensile energy-to-break of at least 15 J/g.

In one embodiment, the tensile strength of the tapes is at least 1.2 GPa, more in particular at least 1.5 GPa, still more in particular at least 1.8 GPa, even more in particular at least 2.0 GPa. Tensile strength is determined in accordance with ASTM D882-00.

In another embodiment, the tapes have a tensile modulus of at least 50 GPa. The modulus is determined in accordance with ASTM D822-00. More in particular, the tapes may have a tensile modulus of at least 80 GPa, more in particular at least 100 GPa.

In another embodiment, the tapes have a tensile energy to break of at least 20 J/g, in particular at least 25 J/g.

The tensile energy to break is determined in accordance with ASTM D882-00 using a strain rate of 50%/min. It is calculated by integrating the energy per unit mass under the stress-strain curve.

Suitable inorganic tapes having a high tensile strength are for example tapes from glass, carbon, and ceramic materials. Suitable organic tapes having a high tensile strength are for example tapes made of aramid, of liquid crystalline polymer, and of highly oriented polymers such as polyesters, polyvinylalcohols, polyolefineketone (POK), polybenzobisoxazoles, polybenz(obis)imidazoles, poly{2,6-diimidazo[4,5-b:4,5-e]-pyridinylene-1,4(2,5-dihydroxy)phenylene} (PIPD or M5) and polyacrylonitrile. The use of combinations of materials is also envisaged, in particular the combination of polyolefins like polyethylene and polypropylene with glass, carbon, or ceramic materials is envisaged.

In the present invention the use of homopolymers and copolymers of polyethylene and polypropylene is preferred. These polyolefins may contain small amounts of one or more other polymers, in particular other alkene-1-polymers.

It is preferred for the tapes in the present invention sheet to be high-drawn tapes of high-molecular weight linear polyethylene. High molecular weight here means a weight average molecular weight of at least 300 000 g/mol. Linear polyethylene here means polyethylene having fewer than 1 side chain per 100 C atoms, preferably fewer than 1 side chain per 300 C atoms. The polyethylene may also contain up to 5 mol % of one or more other alkenes, which are copolymerisable therewith, such as propylene, butene, pentene, 4-methylpentene, and octene.

It may be particularly preferred to use tapes of ultra-high molecular weight polyethylene (UHMWPE), that is, polyethylene with a weight average molecular weight of at least 500 000 g/mol. The use of tapes, in particular fibers or tapes, with a molecular weight of at least 1*10⁶ g/mol may be particularly preferred. The maximum molecular weight of the UHMWPE tapes suitable for use in the present invention is not critical. As a general value a maximum value of 1*10⁸ g/mol may be mentioned. The molecular weight distribution and molecular weigh averages (Mw, Mn, Mz) are determined in accordance with ASTM D 6474-99 at a temperature of 160° C. using 1,2,4-trichlorobenzene (TCB) as solvent. Appropriate chromatographic equipment (PL-GPC220 from Polymer Laboratories) including a high temperature sample preparation device (PL-SP260) may be used. The system is calibrated using sixteen polystyrene standards (Mw/Mn <1.1) in the molecular weight range 5*10³ to 8*10⁶ gram/mole.

The molecular weight distribution may also be determined using melt rheometry. Prior to measurement, a polyethylene sample to which 0.5 wt % of an antioxidant such as IRGANOX 1010 has been added to prevent thermo-oxidative degradation, would first be sintered at 50° C. and 200 bars. Disks of 8 mm diameter and thickness 1 mm obtained from the sintered polyethylenes are heated fast (˜30° C./min) to well above the equilibrium melting temperature in the rheometer under nitrogen atmosphere. For an example, the disk was kept at 180 C for two hours or more. The slippage between the sample and rheometer discs may be checked with the help of an oscilloscope. During dynamic experiments two output signals from the rheometer i.e. one signal corresponding to sinusoidal strain, and the other signal to the resulting stress response, are monitored continuously by an oscilloscope. A perfect sinusoidal stress response, which can be achieved at low values of strain was an indicative of no slippage between the sample and discs. Rheometry may be carried out using a plate-plate rheometer such as Rheometrics RMS 800 from TA Instruments. The Orchestrator Software provided by the TA Instruments, which makes use of the Mead algorithm, may be used to determine molar mass and molar mass distribution from the modulus vs frequency data determined for the polymer melt. The data is obtained under isothermal conditions between 160-220° C. To get the good fit angular frequency region between 0.001 to 100 rad/s and constant strain in the linear viscoelastic region between 0.5 to 2% should be chosen. The time-temperature superposition is applied at a reference temperature of 190° C. To determine the modulus below 0.001 frequency (rad/s) stress relaxation experiments may be performed. In the stress relaxation experiments, a single transient deformation (step strain) to the polymer melt at fixed temperature is applied and maintained on the sample and the time dependent decay of stress is recorded.

In a preferred embodiment of the present invention, tapes of UHMWPE are used which have a high molecular weight, and a narrow molecular weight distribution. It has been found that the selection of a material with a narrow molecular weight distribution leads to the formation of a material with a homogeneous crystalline structure, and therewith to improved mechanical properties and fracture toughness. Tapes of this type will for ease of reference further be indicated as narrow molecular weight distribution tapes or MwMn tapes.

In one embodiment of the present invention, at least some of the tapes are polyethylene tapes which have a weight average molecular weight of at least 100 000 gram/mole, and an Mw/Mn ratio of at most 6. It has been found that the selection of tapes meeting these criteria results in a molded ballistic material with particularly advantageous properties.

Within this embodiment it is preferred for at least 20 wt. %, calculated on the total weight of the tapes present in the ballistic resistant molded article to be MwMn tapes, in particular at least 50 wt. %, more in particular, at least 75 wt. %, still more in particular at least 85 wt. %, or at least 95 wt. %. In one embodiment, all of the tapes present in the ballistic resistant molded article are MwMn tapes.

The MwMn tapes have a weight average molecular weight (Mw) of at least 100 000 gram/mole, in particular at least 300 000 gram/mole, more in particular at least 400 000 gram/mole, still more in particular at least 500 000 gram/mole, in particular between 1.10⁶ gram/mole and 1.10⁸ gram/mole.

The molecular weight distribution of the MwMn tapes is relatively narrow. This is expressed by the Mw (weight average molecular weight) over Mn (number average molecular weight) ratio of at most 6. More in particular the Mw/Mn ratio is at most 5, still more in particular at most 4, even more in particular at most 3. The use of materials with an Mw/Mn ratio of at most 2.5, or even at most 2 is envisaged in particular.

In addition to the molecular weight and Mw/Mn requirements, it is preferred for the MwMn tapes used in one embodiment of the present invention to have a high tensile strength, a high tensile modulus and a high energy absorption, reflected in a high energy-to-break.

In one embodiment, the tensile strength of the MwMn tapes is at least 2.0 GPa, in particular at least 2.5 GPa, more in particular at least 3.0 GPa, still more in particular at least 4 GPa. Tensile strength is determined in accordance with ASTM D882-00.

In another embodiment, the MwMn tapes have a tensile modulus of at least 80 GPa, more in particular at least 100 GPa, still more in particular at least 120 GPa, even more in particular at least 140 GPa, or at least 150 GPa. The modulus is determined in accordance with ASTM D822-00.

In another embodiment, the MwMn tapes have a tensile energy to break of at least 30 J/g, in particular at least 35 J/g, more in particular at least 40 J/g, still more in particular at least 50 J/g. The tensile energy to break is determined in accordance with ASTM D882-00 using a strain rate of 50%/min. It is calculated by integrating the energy per unit mass under the stress-strain curve.

In a preferred embodiment of the present invention the MwMn polyethylene tapes have a high molecular orientation as is evidenced by their XRD diffraction pattern.

In one embodiment of the present invention, MwMn tapes are used in the ballistic material, which have a 200/110 uniplanar orientation parameter Φ of at least 3. The 200/110 uniplanar orientation parameter Φ is defined as the ratio between the 200 and the 110 peak areas in the X-ray diffraction (XRD) pattern of the tape sample as determined in reflection geometry.

Wide angle X-ray scattering (WAXS) is a technique that provides information on the crystalline structure of matter. The technique specifically refers to the analysis of Bragg peaks scattered at wide angles. Bragg peaks result from long-range structural order. A WAXS measurement produces a diffraction pattern, i.e. intensity as function of the diffraction angle 2θ (this is the angle between the diffracted beam and the primary beam).

The 200/110 uniplanar orientation parameter gives information about the extent of orientation of the 200 and 110 crystal planes with respect to the tape surface. For a tape sample with a high 200/110 uniplanar orientation the 200 crystal planes are highly oriented parallel to the tape surface. It has been found that a high uniplanar orientation is generally accompanied by a high tensile strength and high tensile energy to break. The ratio between the 200 and 110 peak areas for a specimen with randomly oriented crystallites is around 0.4. However, in the tapes that are preferentially used in one embodiment of the present invention the crystallites with indices 200 are preferentially oriented parallel to the film surface, resulting in a higher value of the 200/110 peak area ratio and therefore in a higher value of the uniplanar orientation parameter.

The value for the 200/110 uniplanar orientation parameter may be determined using an X-ray diffractometer. A Bruker-AXS D8 diffractometer equipped with focusing multilayer X-ray optics (Göbel mirror) producing Cu-Kα radiation (K wavelength=1.5418 Å) is suitable. Measuring conditions: 2 mm anti-scatter slit, 0.2 mm detector slit and generator setting 40 kV, 35 mA. The tape specimen is mounted on a sample holder, e.g. with some double-sided mounting tape. The preferred dimensions of the tape sample are 15 mm×15 mm (1×w). Care should be taken that the sample is kept perfectly flat and aligned to the sample holder. The sample holder with the tape specimen is subsequently placed into the D8 diffractometer in reflection geometry (with the normal of the tape perpendicular to the goniometer and perpendicular to the sample holder). The scan range for the diffraction pattern is from 5° to 40° (2θ) with a step size of 0.02° (2θ) and a counting time of 2 seconds per step. During the measurement the sample holder spins with 15 revolutions per minute around the normal of the tape, so that no further sample alignment is necessary. Subsequently the intensity is measured as function of the diffraction angle 2θ. The peak area of the 200 and 110 reflections is determined using standard profile fitting software, e.g. Topas from Bruker-AXS. As the 200 and 110 reflections are single peaks, the fitting process is straightforward and it is within the scope of the skilled person to select and carry out an appropriate fitting procedure. The 200/110 uniplanar orientation parameter is defined as the ratio between the 200 and 110 peak areas. This parameter is a quantitative measure of the 200/110 uniplanar orientation.

The MwMn tapes used in one embodiment of the ballistic material according to the invention have a 200/110 uniplanar orientation parameter of at least 3. It may be preferred for this value to be at least 4, more in particular at least 5, or at least 7. Higher values, such as values of at least 10 or even at least 15 may be particularly preferred. The theoretical maximum value for this parameter is infinite if the peak area 110 equals zero. High values for the 200/110 uniplanar orientation parameter are often accompanied by high values for the strength and the energy to break.

In one embodiment of the present invention, the MwMn tapes used therein have a DSC crystallinity of at least 74%, more in particular at least 80%. The DSC crystallinity can be determined as follows using differential scanning calorimetry (DSC), for example on a Perkin Elmer DSC7. Thus, a sample of known weight (2 mg) is heated from 30 to 180° C. at 10° C. per minute, held at 180° C. for 5 minutes, and then cooled at 10° C. per minute. The results of the DSC scan may be plotted as a graph of heat flow (mW or mJ/s; y-axis) against temperature (x-axis). The crystallinity is measured using the data from the heating portion of the scan. An enthalpy of fusion ΔH (in J/g) for the crystalline melt transition is calculated by determining the area under the graph from the temperature determined just below the start of the main melt transition (endotherm) to the temperature just above the point where fusion is observed to be completed. The calculated ΔH is then compared to the theoretical enthalpy of fusion (ΔH_{c} of 293 J/g) determined for 100% crystalline PE at a melt temperature of approximately 140° C. A DSC crystallinity index is expressed as the percentage 100(ΔH/ΔH_{c}).

In one embodiment, the MwMn tapes used in the present invention have a DSC crystallinity of at least 85%, more in particular at least 90%.

The polyethylene used in one embodiment of the present invention can be a homopolymer of ethylene or a copolymer of ethylene with a co-monomer which is another alpha-olefin or a cyclic olefin, both with generally between 3 and 20 carbon atoms. Examples include propene, 1-butene, 1-pentene, 1-hexene, 1-heptene, 1-octene, cyclohexene, etc. The use of dienes with up to 20 carbon atoms is also possible, e.g., butadiene or 1-4 hexadiene. The amount of non-ethylene alpha-olefin in the ethylene homopolymer or copolymer used in the process according to the invention preferably is at most 10 mole %, preferably at most 5 mole %, more preferably at most 1 mole %. If a non-ethylene alpha-olefin is used, it is generally present in an amount of at least 0.001 mol. %, in particular at least 0.01 mole %, still more in particular at least 0.1 mole %. The use of a material which is substantially free from non-ethylene alpha-olefin is preferred. Within the context of the present specification, the wording substantially free from non-ethylene alpha-olefin is intended to mean that the only amount non-ethylene alpha-olefin present in the polymer are those the presence of which cannot reasonably be avoided.

In general, the MwMn tapes used in the present invention have a polymer solvent content of less than 0.05 wt. %, in particular less than 0.025 wt. %, more in particular less than 0.01 wt. %.

The tapes used in the present invention, in particular the MwMn tapes may have a high strength in combination with a high linear density. In the present application the linear density is expressed in dtex. This is the weight in grams of 10.000 metres of film. In one embodiment, the film according to the invention has a denier of at least 3000 dtex, in particular at least 5000 dtex, more in particular at least 10000 dtex, even more in particular at least 15000 dtex, or even at least 20000 dtex, in combination with strengths of, as specified above, at least 2.0 GPa, in particular at least 2.5 GPA, more in particular at least 3.0 GPa, still more in particular at least 3.5 GPa, and even more in particular at least 4.

In one embodiment of the present invention, the MwMn tapes are MwMn tapes manufactured by a process which comprises subjecting a starting polyethylene with a weight average molecular weight of at least 100 000 gram/mole, an elastic shear modulus G_{N}⁰, determined directly after melting at 160° C. of at most 1.4 MPa, and a Mw/Mn ratio of at most 6 to a compacting step and a stretching step under such conditions that at no point during the processing of the polymer its temperature is raised to a value above its melting point.

The starting material for said manufacturing process is a highly disentangled UHMWPE. This can be seen from the combination of the weight average molecular weight, the Mw/Mn ratio, and the elastic modulus. For further elucidation and preferred embodiments as regards the molecular weight and the Mw/Mn ratio of the starting polymer, reference is made to what has been stated above for the MwMn tapes. In particular, in this process it is preferred for the starting polymer to have a weight average molecular weight of at least 500 000 gram/mole, in particular between 1.10⁶ gram/mole and 1.10⁸ gram/mole.

As indicated above, the starting polymer has an elastic shear modulus G_{N}⁰ determined directly after melting at 160° C. of at most 1.4 MPa, more in particular at most 1.0 MPa, still more in particular at most 0.9 MPa, even more in particular at most 0.8 MPa, and even more in particular at most 0.7. The wording “directly after melting” means that the elastic modulus is determined as soon as the polymer has melted, in particular within 15 seconds after the polymer has melted. For this polymer melt, the elastic modulus typically increases from 0.6 to 2.0 MPa in several hours.

The elastic shear modulus directly after melting at 160° C. is a measure for the degree of entangledness of the polymer. G_{N}⁰ is the elastic shear modulus in the rubbery plateau region. It is related to the average molecular weight between entanglements Me, which in turn is inversely proportional to the entanglement density. In a thermodynamically stable melt having a homogeneous distribution of entanglements, Me can be calculated from G_{N}⁰ via the formula G_{N}⁰=g_{N}ρRT/Mₑ, where g_{N} is a numerical factor set at 1, rho is the density in g/cm³, R is the gas constant and T is the absolute temperature in K. A low elastic modulus thus stands for long stretches of polymer between entanglements, and thus for a low degree of entanglement. The adopted method for the investigation on changes in with the entanglements formation is the same as described in publications (Rastogi, S., Lippits, D., Peters, G., Graf, R., Yefeng, Y. and Spiess, H., “Heterogeneity in Polymer Melts from Melting of Polymer Crystals”, Nature Materials, 4(8), 1 Aug. 2005, 635-641 and PhD thesis Lippits, D. R., “Controlling the melting kinetics of polymers; a route to a new melt state”, Eindhoven University of Technology, dated 6 Mar. 2007, ISBN 978-90-386-0895-2).

The starting polymer for use in this embodiment may be manufactured by a polymerisation process wherein ethylene, optionally in the presence of other monomers as discussed above, is polymerised in the presence of a single-site polymerisation catalyst at a temperature below the crystallisation temperature of the polymer, so that the polymer crystallises immediately upon formation. This will lead to a material with an Mw/Mn ratio in the claimed range.

In particular, reaction conditions are selected such that the polymerisation speed is lower than the crystallisation speed. These synthesis conditions force the molecular chains to crystallize immediately upon their formation, leading to a rather unique morphology, which differs substantially from the one obtained from the solution or the melt. The crystalline morphology created at the surface of a catalyst will highly depend on the ratio between the crystallization rate and the growth rate of the polymer. Moreover, the temperature of the synthesis, which is in this particular case also crystallization temperature, will strongly influence the morphology of the obtained UHMW-PE powder. In one embodiment the reaction temperature is between −50 and +50° C., more in particular between −15 and +30° C. It is well within the scope of the skilled person to determine via routine trial and error which reaction temperature is appropriate in combination with which type of catalyst, polymer concentrations and other parameters influencing the reaction. To obtain a highly disentangled UHMWPE it is desirable that the polymerisation sites are sufficiently far removed from each other to prevent entangling of the polymer chains during synthesis. This can be done using a single-site catalyst, which is dispersed homogenously through the crystallisation medium in low concentrations. More in particular, concentrations less than 1.10⁻⁴ mol catalyst per liter, in particular less than 1.10⁻⁵ mol catalyst per liter reaction medium may be appropriate. Supported single site catalyst may also be used, as long as care is taken that the active sites are sufficiently far removed from each other to prevent substantial entanglement of the polymers during formation. Suitable methods for manufacturing polyethylenes used in the present invention are known in the art. Reference is made, for example, to WO01/21668 and US20060142521.

The disentangled UHMWPE that may be used in the present invention may have a bulk density, which is significantly lower than the bulk density of conventional UWMWPEs. More in particular, the UHMWPE used in the process according to the invention may have a bulk density below 0.25 g/cm³, in particular below 0.18 g/cm³, still more in particular below 0.13 g/cm³. The bulk density may be determined in accordance with ASTM-D1895. A fair approximation of this value can be obtained as follows. A sample of UHMWPE powder is poured into a measuring beaker of exact 100 ml. After scraping away the surplus of material, the weight of the content of the beaker is determined and the bulk density is calculated.

The polymer is provided in particulate form, for example in the form of a powder, or in any other suitable particulate form. Suitable particles have a particle size of up to 5000 micron, preferably up to 2000 micron, more in particular up to 1000 micron. The particles preferably have a particle size of at least 1 micron, more in particular at least 10 micron. The particle size distribution may be determined by laser diffraction (PSD, Sympatec Quixel) as follows. The sample is dispersed into surfactant-containing water and treated ultrasonic for 30 seconds to remove agglomerates/entanglements. The sample is pumped through a laser beam and the scattered light is detected. The amount of light diffraction is a measure for the particle size.

The compacting step is carried out to integrate the polymer particles into a single object, e.g., in the form of a mother sheet. The stretching step is carried out to provide orientation to the polymer and manufacture the final product. The two steps are carried out at a direction perpendicular to each other. It is noted that it is within the scope of the present invention to combine these elements in a single step, or to carry out the process in different steps, each step performing one or more of the compacting and stretching elements. For example, in one embodiment of the process according to the invention, the process comprises the steps of compacting the polymer powder to form a mothersheet, rolling the plate to form rolled mothersheet and subjecting the rolled mothersheet to a stretching step to form a polymer film.

The compacting force applied in the process according to the invention generally is 10-10000 N/cm², in particular 50-5000 N/cm², more in particular 100-2000 N/cm². The density of the material after compacting is generally between 0.8 and 1 kg/dm³, in particular between 0.9 and 1 kg/dm³.

In the process the compacting and rolling step is generally carried out at a temperature of at least 1° C. below the unconstrained melting point of the polymer, in particular at least 3° C. below the unconstrained melting point of the polymer, still more in particular at least 5° C. below the unconstrained melting point of the polymer. Generally, the compacting step is carried out at a temperature of at most 40° C. below the unconstrained melting point of the polymer, in particular at most 30° C. below the unconstrained melting point of the polymer, more in particular at most 10° C.

In the process the stretching step is generally carried out at a temperature of at least 1° C. below the melting point of the polymer under process conditions, in particular at least 3° C. below the melting point of the polymer under process conditions, still more in particular at least 5° C. below the melting point of the polymer under process conditions. As the skilled person is aware, the melting point of polymers may depend upon the constraint under which they are put. This means that the melting temperature under process conditions may vary from case to case. It can easily be determined as the temperature at which the stress tension in the process drops sharply. Generally, the stretching step is carried out at a temperature of at most 30° C. below the melting point of the polymer under process conditions, in particular at most 20° C. below the melting point of the polymer under process conditions, more in particular at most 15° C.

In one embodiment of the present invention, the stretching step encompasses at least two individual stretching steps, wherein the first stretching step is carried out at a lower temperature than the second, and optionally further, stretching steps. In one embodiment, the stretching step encompasses at least two individual stretching steps wherein each further stretching step is carried out at a temperature, which is higher than the temperature of the preceding stretching step.

As will be evident to the skilled person, this method can be carried out in such a manner that individual steps may be identified, e.g., in the form of the films being fed over individual hot plates of a specified temperature. The method can also be carried out in a continuous manner, wherein the film is subjected to a lower temperature in the beginning of the stretching process and to a higher temperature at the end of the stretching process, with a temperature gradient being applied in between. This embodiment can for example be carried out by leading the film over a hot plate which is equipped with temperature zones, wherein the zone at the end of the hot plate nearest to the compaction apparatus has a lower temperature than the zone at the end of the hot plate furthest from the compaction apparatus.

In one embodiment, the difference between the lowest temperature applied during the stretching step and the highest temperature applied during the stretching step is at least 3° C., in particular at least 7° C., more in particular at least 10° C. In general, the difference between the lowest temperature applied during the stretching step and the highest temperature applied during the stretching step is at most 30° C., in particular at most 25° C.

The unconstrained melting temperature of the starting polymer is between 138 and 142° C. and can easily be determined by the person skilled in the art. With the values indicated above this allows calculation of the appropriate operating temperature. The unconstrained melting point may be determined via DSC (differential scanning calorimetry) in nitrogen, over a temperature range of +30 to +180° C. and with an increasing temperature rate of 10° C./minute. The maximum of the largest endothermic peak at from 80 to 170° C. is evaluated here as the melting point.

In the conventional processing of UHMWPE it was necessary to carry out the process at a temperature which was very close to the melting temperature of the polymer, e.g., within 1 to 3 degrees therefrom. It has been found that the selection of the specific starting UHMWPE used in the process according to the invention makes it possible to operate at values which are more below the melting temperature of the polymer than has been possible in the prior art. This makes for a larger temperature operating window that makes for better process control.

It has also been found that, as compared to conventional processing of UHMWPE, materials with a strength of at least 2 GPa can be manufactured at higher deformation speeds. The deformation speed is directly related to the production capacity of the equipment. For economical reasons it is desirable to produce at a deformation rate, which is as high as possible without detrimentally affecting the mechanical properties of the film. In particular, it has been found that it is possible to manufacture a material with a strength of at least 2 GPa by a process wherein the stretching step that is required to increase the strength of the product from 1.5 GPa to at least 2 GPa is carried out at a rate of at least 4% per second. In conventional polyethylene processing it is not possible to carry out this stretching step at this rate. While in conventional UHMWPE processing the initial stretching steps, to a strength of, say, or 1.5 GPa may be carried out at a rate of above 4% per second, the final steps, required to increase the strength of the film to a value of 2 GPa or higher, must be carried out at a rate well below 4% per second, as otherwise the film will break. In contrast, in the process according to the invention it has been found that it is possible to stretch intermediate film with a strength of 1.5 GPa at a rate of at least 4% per second, to obtain a material with a strength of at least 2 GPa. For further preferred values of the strength reference is made to what has been stated above. It has been found that the rate applied in this step may be at least 5% per second, at least 7% per second, at least 10% per second, or even at least 15% per second.

The strength of the film is related to the stretching ratio applied. Therefore, this effect can also be expressed as follows. In one embodiment of the invention, the stretching step of the process according to the invention can be carried out in such a manner that the stretching step from a stretching ratio of 80 to a stretching ratio of at least 100, in particular at least 120, more in particular at least 140, still more in particular of at least 160 is carried out at the stretching rate indicated above.

In still a further embodiment, the stretching step of the process according to the invention can be carried out in such a manner that the stretching step from a material with a modulus of 60 GPa to a material with a modulus of at least at least 80 GPa, in particular at least 100 GPa, more in particular at least 120 GPa, at least 140 GPa, or at least 150 GPa is carried out at the rate indicated above.

In will be evident to the skilled person that the intermediate products with a strength of 1.5 GPa, a stretching ratio of 80, and/or a modulus of 60 GPa are used, respectively, as starting point for the calculation of when the high-rate stretching step starts. This does not mean that a separately identifiable stretching step is carried out where the starting material has the specified value for strength, stretching ratio, or modulus. A product with these properties may be formed as intermediate product during a stretching step. The stretching ratio will then be calculated back to a product with the specified starting properties. It is noted that the high stretching rate described above is dependent upon the requirement that all stretching steps, including the high-rate stretching step or steps are carried out at a temperature below the melting point of the polymer under process conditions.

In this manufacturing process the polymer is provided in particulate form, for example in the form of a powder. The compacting step is carried out to integrate the polymer particles into a single object, e.g., in the form of a mother sheet. The stretching step is carried out to provide orientation to the polymer and manufacture the final product. The two steps are carried out at a direction perpendicular to each other. It is noted that these elements may be combined in a single step, or may be carried out in separate steps, each step performing one or more of the compacting and stretching elements. For example, in one embodiment the process comprises the steps of compacting the polymer powder to form a mothersheet, rolling the plate to form rolled mothersheet and subjecting the rolled mothersheet to a stretching step to form a polymer film.

The compacting force applied in the process according to the invention generally is 10-10000 N/cm², in particular 50-5000 N/cm², more in particular 100-2000 N/cm². The density of the material after compacting is generally between 0.8 and 1 kg/dm³, in particular between 0.9 and 1 kg/dm³.

The compacting and rolling step is generally carried out at a temperature of at least 1° C. below the unconstrained melting point of the polymer, in particular at least 3° C. below the unconstrained melting point of the polymer, still more in particular at least 5° C. below the unconstrained melting point of the polymer. Generally, the compacting step is carried out at a temperature of at most 40° C. below the unconstrained melting point of the polymer, in particular at most 30° C. below the unconstrained melting point of the polymer, more in particular at most 10° C.

The stretching step is generally carried out at a temperature of at least 1° C. below the melting point of the polymer under process conditions, in particular at least 3° C. below the melting point of the polymer under process conditions, still more in particular at least 5° C. below the melting point of the polymer under process conditions. As the skilled person is aware, the melting point of polymers may depend upon the constraint under which they are put. This means that the melting temperature under process conditions may vary from case to case. It can easily be determined as the temperature at which the stress tension in the process drops sharply. Generally, the stretching step is carried out at a temperature of at most 30° C. below the melting point of the polymer under process conditions, in particular at most 20° C. below the melting point of the polymer under process conditions, more in particular at most 15° C.

The unconstrained melting temperature of the starting polymer in this embodiment is between 138 and 142° C. and can easily be determined by the person skilled in the art. With the values indicated above this allows calculation of the appropriate operating temperature. The unconstrained melting point may be determined via DSC (differential scanning calorimetry) in nitrogen, over a temperature range of +30 to +180° C. and with an increasing temperature rate of 10° C./minute. The maximum of the largest endothermic peak at from 80 to 170° C. is evaluated here as the melting point.

Conventional apparatus may be used to carry out the compacting step. Suitable apparatus include heated rolls, endless belts, etc.

The stretching step is carried out to manufacture the polymer film. The stretching step may be carried out in one or more steps in a manner conventional in the art. A suitable manner includes leading the film in one or more steps over a set of rolls both rolling in process direction wherein the second roll rolls faster that the first roll. Stretching can take place over a hot plate or in an air circulation oven.

The total stretching ratio may be at least 80, in particular at least 100, more in particular at least 120, still more in particular at least 140, even more in particular at least 160. The total stretching ratio is defined as the area of the cross-section of the compacted mothersheet divided by the cross-section of the drawn film produced from this mothersheet.

The process is carried out in the solid state. The final polymer film has a polymer solvent content of less than 0.05 wt. %, in particular less than 0.025 wt. %, more in particular less than 0.01 wt. %.

The ballistic-resistant molded article of the present invention may or may not comprise a matrix material. The term “matrix material” means a material, which binds the tapes and/or the sheets together. In conventional ballistic materials based on fibers, matrix material is required to adhere the fibers together to form unidirectional monolayers. The use of sheets comprising woven tapes both as weft and as warp dispenses with the necessity of using matrix material for this reason, as the tapes are bonded together through their woven structure. Therefore, this will allow the use of less matrix material or even dispense with the use of matrix material altogether.

In one embodiment of the present invention the ballistic-resistant molded article does not contain a matrix material. While it is believed that the matrix material has a lower contribution to the ballistic effectivity of the system than the tapes, the matrix-free embodiment may make an efficient material as regards its ballistic effectivity per weight ratio.

In another embodiment of the present invention, the ballistic resistant molded article comprises a matrix material.

In this embodiment, the matrix material may be present to improve the delamination properties of the material. It may also contribute to the ballistic performance.

In one embodiment of the present invention, matrix material is provided within the sheets themselves, where it serves to adhere tapes to each other, for example to stabilise the fabric after weaving. This embodiment can, for example, be obtained by providing the tape with a material which does not interfere with the tape-weaving process, but which will serve as a bonding material after application of heat and/or pressure.

In another embodiment of the present invention, matrix material is provided on the sheet, to adhere the sheet to further sheets within the stack.

One way of providing the matrix material onto the sheets is the provision of one or more films of matrix material on the top side, bottom side or both sides of the sheets. If so desired, the films may be caused to adhere to the sheet, e.g., by passing the films together with the sheet through a heated pressure roll or press.

Another way of providing the matrix material onto the sheets is by applying an amount of a liquid substance containing the organic matrix material onto the sheet. This embodiment has the advantage that it allows simple application of matrix material. The liquid substance may be for example a solution, a dispersion, or a melt of the organic matrix material. If a solution or a dispersion of the matrix material is used, the process also comprises evaporating the solvent or dispersant. Furthermore, the matrix material may be applied in vacuo. The liquid material may be applied homogeneously over the entire surface of the sheet, as the case may be. However, it is also possible to apply the matrix material in the form of a liquid material inhomogeneously over the surface of the sheet, as the case may be. For example, the liquid material may be applied in the form of dots or stripes, or in any other suitable pattern.

In one embodiment of the present invention the matrix material is applied in the form of a web, wherein a web is a discontinuous polymer film, that is, a polymer film with holes. This allows the provision of low weights of matrix materials.

In another embodiment of the present invention, the matrix material is applied in the form of strips, yarns, or fibers of polymer material, the latter for example in the form of a woven or non-woven yarn of fiber web or other polymeric fibrous weft. Again, this allows the provision of low weights of matrix materials.

In various embodiments described above, the matrix material is distributed inhomogeneously over the sheets. In one embodiment of the present invention the matrix material is distributed inhomogeneously within the compressed stack. In this embodiment more matrix material may be provided there were the compressed stack encounters the most influences from outside which may detrimentally affect stack properties.

The organic matrix material may wholly or partially consist of a polymer material, which optionally may contain fillers usually employed for polymers. The polymer may be a thermoset or thermoplastic or mixtures of both. Preferably a soft plastic is used, in particular it is preferred for the organic matrix material to be an elastomer with a tensile modulus (at 25° C.) of at most 41 MPa. The use of non-polymeric organic matrix material is also envisaged. The purpose of the matrix material is to help to adhere the tapes and/or the sheets together where required, and any matrix material, which attains this purpose is suitable as matrix material.

Preferably, the elongation to break of the organic matrix material is greater than the elongation to break of the reinforcing tapes. The elongation to break of the matrix preferably is from 3 to 500%. These values apply to the matrix material as it is in the final ballistic-resistant article.

Thermosets and thermoplastics that are suitable for the sheet are listed in for instance EP 833742 and WO-A-91/12136. Preferably, vinylesters, unsaturated polyesters, epoxides or phenol resins are chosen as matrix material from the group of thermosetting polymers. These thermosets usually are in the sheet in partially set condition (the so-called B stage) before the stack of sheets is cured during compression of the ballistic-resistant molded article. From the group of thermoplastic polymers polyurethanes, polyvinyls, polyacrylates, polyolefins or thermoplastic, elastomeric block copolymers such as polyisoprene-polyethylenebutylene-polystyrene or polystyrene-polyisoprenepolystyrene block copolymers are preferably chosen as matrix material.

When a matrix material is used, it generally applied in an amount of at least 0.2 wt. %. It may be preferred for the matrix material to be present in an amount of at least 1 wt. %, more in particular in an amount of at least 2 wt. %, in some instances at least 2.5 wt. %. Matrix material is generally applied in an amount of at most 30 wt. %. The use of more than 30 wt. % of matrix material generally does not improve the properties of the molded article. It is believed that the presence of large amounts of matrix material may not always result in good ballistic properties of the panel. Therefore, it may be preferred to use a lower amount of matrix material. In some embodiments it may be preferred for the matrix material to be present in an amount of at most 12 wt. %, preferably at most 8 wt. %, more preferably at most 7 wt. %, sometimes at most 6.5 wt.%.

The compressed stack of sheets used in the ballistic-resistant material according to the invention, and the material itself, should meet the requirements of class II of the NIJ Standard-0101.04 P-BFS performance test. In a preferred embodiment, the requirements of class IIIa of said Standard are met, in an even more preferred embodiment, the requirements of class III are met, or the requirements of even higher classes. This ballistic performance is preferably accompanied by a low areal weight, in particular an areal weight of at most 19 kg/m², more in particular at most 16 kg/m². In some embodiments, the areal weight of the stack may be as low as 15 kg/m². The minimum areal weight of the stack is given by the minimum ballistic resistance required, and depends on the class.

The ballistic-resistant material according to the invention preferably has a peel strength of at least 5N, more in particular at least 5.5 N, determined in accordance with ASTM-D 1876-00, except that a head speed of 100 mm/minute is used.

Depending on the final use and on the thickness of the individual sheets, the number of sheets in the stack in the ballistic resistant article according to the invention is generally at least 2, in particular at least 4, more in particular at least 8. The number of sheets is generally at most 500, in particular at most 400.

The invention also pertains to a method for manufacturing a ballistic-resistant molded article comprising the steps of providing sheets comprising tapes of a reinforcing material, wherein at least one sheet comprises woven tapes as weft and as warp, stacking the and compressing the stack under a pressure of at least 0.5 MPa.

The pressure to be applied is intended to ensure the formation of a ballistic-resistant molded article with adequate properties. The pressure is at least 0.5 MPa. A maximum pressure of at most 50 MPA may be mentioned.

Where necessary, the temperature during compression is selected such that any matrix material is brought above its softening or melting point, if this is necessary to cause the matrix to help adhere the sheets to each other. Compression at an elevated temperature is intended to mean that the molded article is subjected to the given pressure for a particular compression time at a compression temperature above the softening or melting point of the organic matrix material and below the softening or melting point of the tapes.

The required compression time and compression temperature depend on the nature of the tape, the nature of the matrix material, if present, and on the thickness of the molded article and can be readily determined by one skilled in the art.

Where the compression is carried out at elevated temperature, the cooling of the compressed material should also take place under pressure. Cooling under pressure is intended to mean that the given minimum pressure is maintained during cooling at least until so low a temperature is reached that the structure of the molded article can no longer relax and deform under atmospheric pressure. It is within the scope of the skilled person to determine this temperature on a case by case basis. Where applicable it is preferred for cooling at the given minimum pressure to be down to a temperature at which the organic matrix material has largely or completely solidified or crystallized and below the relaxation temperature of the reinforcing tapes. The pressure during the cooling does not need to be equal to the pressure at the high temperature. During cooling, the pressure should be monitored so that appropriate pressure values are maintained, to compensate for decrease in pressure caused by shrinking of the molded article and the press.

Depending on the nature of the matrix material, if present, for the manufacture of a ballistic-resistant molded article in which the reinforcing tapes in the sheet are high-drawn tapes of high-molecular weight linear polyethylene, the compression temperature is preferably 115 to 138° C. and cooling to below 70° C. is effected at a constant pressure. Within the present specification the temperature of the material, e.g., compression temperature refers to the temperature at half the thickness of the molded article.

In the process of the invention the stack may be made starting from individual sheets. Individual sheets may sometimes be difficult to handle, however. Therefore, the present invention also encompasses an embodiment wherein the stack is made from consolidated sheet packages containing from 2 to 16 sheets, as a rule 2, 4 or 8. Consolidated is intended to mean that the sheets are firmly attached to one another. Very good results are achieved if the sheet packages, too, are compressed.

### Example 1

A ballistic material according to the invention was manufactured as follows.

Sheets were manufactured by weaving ultra-high molecular weight polyethylene tapes in a plain weave. The tapes used as warp had a width of 20 mm, and a thickness of 64 microns. The tapes had a tensile strength of 1.81 GPa, a tensile modulus of 100 GPa, and an elongation at break of 1.86%. The polyethylene had a molecular weight Mw of 3.6 10⁶ gram/mole and a Mw/Mn ratio of 8.3. The tape used as weft had a width of 25 mm, but otherwise the same properties.

Sheets were stacked, without the presence of a matrix material. The stack was compressed at a temperature of 136-137° C., at a pressure of 60 bar. The material was cooled down and removed from the press to form a ballistic-resistant molded article. The panel had an areal weight of 3.4 kg/m². The plate was tested for ballistic performance in accordance with NIJ IIIA 0.101.04, with a bullet velocity of 530 m/s. The bullet energy was 2.19 kJ, and the SEA was 644 Jm²/kg. It is interesting to compare this with Sample 24 in Table 7 of EP191306, where polyethylene tapes with a width of 6.4 mm and comparable strength properties (tenacity of 23.9 g/denier, which is 2.0 GPa, and a modulus of 865.9 gram/denier, which is 72 GPa. In this example, a SEA is obtained of 34.7 Jm²/kg, with a bullet velocity V50 of 1164 ft/sec (355 m/sec).

### Example 2

Example 1 was repeated, except that matrix was applied onto the sheets in a homogeneous layer before stacking. The matrix material used was Prinlin B7137 AL, commercially available from Henkel. The panel had an areal weight of 3.4 kg/m², and a matrix content of 4 wt. %.

The plate was tested for ballistic performance in accordance with NIJ IIIA 0.101.04, with a bullet velocity of 523 m/s. The bullet energy was 2.13 kJ, and the SEA was 628 Jm²/kg.

### Example 3

A ballistic material according to the invention was manufactured as follows.

Sheets were manufactured by weaving ultra-high molecular weight polyethylene tapes in a plain weave. The tapes used had a width of 40 mm, and a thickness of 64 microns. The tapes had a tensile strength of 2.2 GPa, a tensile modulus of 148 GPa, and an elongation at break of 1.7%. The polyethylene had a molecular weight Mw of 4.3 10⁶ gram/mole and a Mw/Mn ratio of 9.8. The same tapes were used as weft and warp.

Matrix was applied onto the woven sheets in a homogeneous layer. The matrix material used was Prinlin B7137 AL, commercially available from Henkel. The sheets were stacked, and the stack was compressed at a temperature of 130-134° C., at a pressure of 60 bar. The material was cooled down and removed from the press to form a ballistic-resistant molded article. The panel had an areal weight of 17.4 kg/m², and a matrix content of 4 wt. %

The panel was tested for ballistic properties in accordance with NIJ III 0.108.01 (hard armor). The panel was able to stop the bullet. It was found that with a bullet velocity of 897 m/s, a bullet energy of 3.86 kJ and a SEA of 222 Jm²/kg were obtained.

1. A ballistic-resistant molded article, comprising:
a compressed stack of sheets comprising a plurality of tapes comprised of a reinforcing material,
wherein at least one sheet of the compressed stack of sheets comprises a plurality of woven tapes as a weft and as a warp, and
wherein at least one tape of the plurality of tapes has a width of at least 10 mm.

2. The ballistic-resistant molded article according to claim 1, wherein the plurality of woven tapes are high-molecular weight polyethylene tapes.

3. The ballistic-resistant molded article according to claim 1, wherein the at least one tape of the plurality of tapes has a width of at least 20 .

4. The ballistic-resistant molded article according to claim 1, wherein a ratio between a width of the plurality of woven tapes in a weft direction and a width of the plurality of woven tapes in a warp direction is between 5:1 and 1:5.

5. The ballistic-resistant molded article according to claim 1, wherein the ballistic-resistant molded article does not comprise a matrix material.

6. The ballistic-resistant molded article according to claim 1, wherein the compressed stack of sheets further comprises a matrix material in an amount of from 0.2-30 wt. %.

7. The ballistic-resistant molded article according to claim 1, wherein the at least one sheet is substantially free from matrix material and the matrix material is present between the compressed stack of sheets.

8. The ballistic-resistant molded article according to claim 1, wherein a plurality of sheets comprising the plurality of woven tapes as weft and as warp are stacked on top of each other, the stacking being carried out in such a manner that tape intersections of one sheet of the plurality of sheets are not stacked on top of tape intersections of adjacent sheets of the compressed stack of sheets.

9. The ballistic-resistant molded article according to claim 1, wherein the plurality of woven tapes are polyethylene tapes having a weight average molecular weight (Mw) of at least 100,000 gram/mole, and a Mw/number average molecular weight (Mw) ratio of less than 6.

10. The ballistic-resistant molded article according to claim 9, wherein the polyethylene tapes have a Mw/Mn ratio of less than 5.

11. The ballistic-resistant molded article according to claim 9, wherein the polyethylene tapes have a 200/110 uniplanar orientation parameter of at least 3.

12. The ballistic-resistant molded according to claim 9, wherein the polyethylene tapes have a tensile strength of at least 2.0 GPa.

13. The ballistic-resistant molded according to claim 9, wherein the polyethylene tapes have a tensile energy to break of at least 30 J/g.

14. A consolidated sheet package comprising the ballistic-resistant molded article of claim 1, wherein the consolidated sheet package comprises 2-16 sheets.

15. A method for manufacturing a ballistic-resistant molded article, the method comprising:
providing a plurality of sheets, each sheet of the plurality of sheets comprising a plurality of tapes comprised of a reinforcing material, wherein at least one sheet of the plurality of sheets comprises a plurality of woven tapes as a weft and as a warp,
stacking the plurality of sheets, and
compressing the stacked sheets under a pressure of at least 0.5 MPa.

16. The ballistic-resistant molded article according to claim 1, wherein the at least one tape of the plurality of tapes has a width of at least 40 mm

17. The ballistic-resistant molded article according to claim 1, wherein a ratio between a width of the plurality of woven tapes in a weft direction and a width of the plurality of woven tapes in a warp direction is between 2:1 and 1:2.

18. The ballistic-resistant molded article according to claim 1, wherein the compressed stack of sheets further comprises a matrix material in an amount of from 0.2-12 wt. %.
